(19) United States
(12) Patent Application Publication
(10) Pub. No.: US 2011/0188860 A1
(43) Pub. Date: Aug. 4, 2011

(54) ELECTRICAL EQUALIZING PROCESSING METHOD AND DEVICE FOR OPTICAL SIGNAL AND OPTICAL FIBER COMMUNICATION SYSTEM

(76) Inventors: Ming Li, Beijing (CN); Fan Zhang, Beijing (CN); Zhangyuan Chen, Beijing (CN); Anshi Xu, Beijing (CN); Liangehuan Li, Shenzhen (CN)

(21) Appl. No.: 13/032,420

(22) Filed: Feb. 22, 2011

Related U.S. Application Data
(63) Continuation of application No. PCT/CN2009/072631, filed on Jul. 6, 2009.

(30) Foreign Application Priority Data
Aug. 28, 2008 (CN) 200810141779.3

(51) Int. Cl. H04J 14/02; H04B 10/00

(52) U.S. Cl. 398/79; 398/115

(57) ABSTRACT

The electrical equalizing processing method for optical signal includes the following steps. An input optical signal is split into N channels of optical signals, in which N is an integer greater or equal to 2; band-pass filtering is performed on the split N channels of optical signals, in which central frequencies of a frequency band used in the performing of band-pass filtering on the N channels of optical signals are not exactly the same, and a passband of the frequency band and a frequency spectrum range of the N channels of optical signals overlap; the N channels of optical signals on which band-pass filtering is performed are converted into corresponding N channels of an analog electrical signal; an electrical equalizing process is performed on the N channels of the analog electrical signal to output an optical signal electrical equalizing processing result.

### CROSS-REFERENCE TO RELATED APPLICATIONS

This application is a continuation of International Application No. PCT/CN2009/072631, filed on Jul. 6, 2009, which claims priority to Chinese Patent Application No. 200810141779.3, filed on Aug. 28, 2008, both of which are hereby incorporated by reference in their entireties.

### FIELD OF THE TECHNOLOGY

The present application relates to the field of communications technology, and more particularly to an electrical equalizing processing method and device for optical signal and an optical fiber communication system.

### BACKGROUND OF THE APPLICATION

Optical fiber communications technology has become one of the main backbones of modern communication, and plays an important role in modern telecommunication network. Its rapid development in recent years and wide application areas are rare in communication history, and the optical fiber communication technology is an important label of the world's new technological revolution and is a main delivery tool for all kinds of information in future information society.

Dispersion is an important factor which affects the performance of an optical communication system. Although the dispersion can be compensated in an optical domain through a dispersion compensation fiber, the dispersion of optical signals is very difficult to be fully compensated through the dispersion compensation fiber, because 1) it is very difficult for the dispersion compensation fiber to precisely compensate the dispersion of the optical signals on each channel in a wavelength division multiplexing system; 2) in an optical fiber communication network, dynamic routing makes accumulated dispersion of the optical signals ever-changing; 3) external environmental factors also have some influence on the dispersion in the optical fiber.

Electrical equalizing technology is an effective dispersion compensating technology, in which low-cost, high-performance processing chips are utilized to equalize an optical signal after the optical signal is converted into an electrical signal, so as to reduce the effect from residual dispersion of a fiber system on signal transmission quality. Maximum likelihood sequence estimation (MLSE) equalizing technology is a common electrical equalizing technology at present.

As shown in FIG. 1, in an existing MLSE equalizing system, a signal after being processed by the wavelength division demultiplexer is first converted by an optical/electrical converter into an analog electrical signal, and is then converted by an analog-to-digital converter (ADC) into a digital signal, and finally, a delivered bit sequence is decided by a digital signal processing (DSP) module. It may be sampled twice per bit period by using the ADC, the DSP module employs an MLSE criterion to decide the delivered bit sequence, the criterion is as follows:

$$d = arg {max}_{s ∈ S} \sum log ( p ( {y}_{n 1} , {y}_{n 2} ) \vert s ) )$$

In the above equation, yₙ=(yₙ₁,yₙ₂) is a vector obtained by sampling in the n-th bit period, S is a set of all possible states, p(yₙ₁,yₙ₂)|S is a combined probability density function of receiving sampled electrical signals with a sending state of s, and d is a decided state. The MLSE criterion can be implemented through Viterbi algorithm.

Feed forward equalization/decision feedback equalization (FFE/DFE) technology is another electrical equalizing technology in the prior art. As shown in FIG. 2, in a traditional FFE/DFE equalizing system, an optical signal after being processed by the wavelength division demultiplexer is first converted into an analog electrical signal through optical/electrical conversion, and then the decided bit sequence is output through an FFE/DFE equalizer.

FIG. 3 is a structural view of an FFE/DFE equalizer. The FFE/DFE equalizer is formed by cascading an FFE equalizer and a DFE equalizer. At the FFE equalizer, an original input signal is delayed for m times whose delay time is an integer fraction of a signal period to produce m channels of signals. The non-delayed original signal and the delayed m channels of signals are respectively amplified or attenuated, and then linearly superimposed into a one-channel signal to output an FFE processing result. A coefficient for the amplification or attenuation can be determined by a minimum mean square error algorithm. The coefficient can be a positive, zero, or a negative, and m can be an integer equal to or greater than 1. During FFE processing, the minimum mean square error algorithm is one of relatively commonly used methods for determining the coefficient used for amplifying or attenuating the non-delayed original signal and the delayed m channels of signals, such algorithms as constant modulus algorithm can also be used for determining the coefficient in the prior art. The DFE equalizer receives the FFE processing result, and at the same time, delays the signals output by the DTE equalizer itself for n times whose delaying time is the signal period, so as to produce corresponding n channels of signals. The delayed n channels of signals are respectively amplified or attenuated, and then linearly superimposed with the FFE processing result into a one-channel signal, and the linearly superimposed one-channel signal is decided to output a DFE processing result. The coefficient for the amplification or attenuation separately performed on the delayed n channels of signals can be determined by using the minimum mean square error algorithm. The coefficient can be a positive, zero, or a negative, and the n can be an integer equal to or greater than 1. During DFE processing, the minimum mean square error algorithm is one of relatively commonly used methods for determining the coefficient used for amplifying or attenuating the delayed signal, such algorithms as constant modulus algorithm can also be used for determining the coefficient in the prior art.

During implementing of embodiments disclosed in the present application, Applicants found that the optical fiber communication system which applies traditional electrical equalizing technology in the prior art has a poor linearity, and has a rigid requirement for optical signal to noise ratio and a small dispersion margin under a given residual dispersion condition in order to guarantee a certain error ratio.

### SUMMARY OF THE APPLICATION

The embodiments provide an electrical equalizing processing method and device for optical signal and an optical fiber communication system, which can reduce the requirement for optical signal to noise ratio for achieving the same error rate under a given residual dispersion condition, and can efficiently improve a dispersion margin of the optical fiber communication system.

To achieve the objectives, an embodiment provides an electrical equalizing processing method for optical signal. The method includes the following steps:

An input optical signal is split into N channels of optical signals, in which N is an integer greater than or equal to 2.

Band-pass filtering is performed on the N channels of optical signals, central frequencies of a frequency band used in the performing of the band-pass filtering on the N channels of optical signals are not exactly the same, and a passband of the frequency band and a frequency spectrum range of the N channels of optical signals overlap.

The N channels of optical signals on which band-pass filtering is performed are converted into corresponding N channels of analog electrical signals.

An electrical equalizing process is performed on the N channels of analog electrical signals to output an optical signal electrical equalizing processing result.

An embodiment provides an electrical equalizing processing device for optical signal. The device includes an optical splitting unit, N filtering units, N optical/electrical converting units, and an electrical equalizing processing unit.

The optical splitting unit is configured to split an input optical signal into N channels of optical signals, in which N is an integer greater than or equal to 2.

The N filtering units corresponding to the N channels of optical signals are configured to perform band-pass filtering on the corresponding optical signals in the N channels of optical signals, central frequencies of a frequency band used in the performing of band-pass filtering on the N channels of optical signals are not exactly the same, and a passband of the frequency band and a frequency spectrum range of the N channels of optical signals overlap.

The N optical/electrical converting units corresponding to the N channels of optical signals on which band-pass filtering is performed are configured to convert such optical signals into corresponding N channels of analog electrical signals.

The electrical equalizing processing unit is configured to perform an electrical equalizing process on the N channels of analog electrical signals to output an optical signal electrical equalizing processing result.

Accordingly, an embodiment further provides an optical fiber communication system which includes an electrical equalizing processing device for optical signal, and the electrical equalizing processing device for optical signal is configured to perform the following operations:

An optical signal transmitted from a transmitter is received, and the received optical signal is split into N channel of the optical signal, in which N is an integer greater than or equal to 2.

Band-pass filtering is performed on the N channels of optical signals, in which a passband of a frequency band used in the performing of band-pass filtering on the N channels of optical signals and a frequency spectrum range of the N channels of optical signals overlap.

The N channels of optical signals on which band-pass filtering is performed are converted into corresponding N channels of analog electrical signals.

An electrical equalizing process is performed on the N channels of analog electrical signals to output an optical signal electrical equalizing processing result.

In the embodiments, band-pass filtering is performed on the split multiple channels of optical signals, central frequencies of a frequency band used in the performing of band-pass filtering on the optical signal are not exactly the same, and the amplitude of an optical signal on which band-pass filtering is performed is related to both the amplitude and the phase of the input optical signal. After the optical signal is converted into an electrical signal, the optical equalizing processing device can obtain more information about the optical signal, which can reduce the requirement for optical signal to noise ratio under a certain residual dispersion value and an error rate standard, thereby improving a dispersion margin of the electrical equalizing processing device.

### BRIEF DESCRIPTION OF THE DRAWINGS

FIG. 1 is a structural view of an existing MLSE equalizing system;

FIG. 2 is a structural view of an existing FFE/DFE equalizing system;

FIG. 3 is a structural view of an existing FFE/DFE equalizer;

FIG. 4 is a flow chart of an electrical equalizing processing method for optical signal according to an embodiment;

FIG. 5 is a flow chart of an electrical equalizing processing method for optical signal according to another embodiment;

FIG. 6 is a flow chart of an electrical equalizing processing method for optical signal according to another embodiment;

FIG. 7 is a schematic diagram of an electrical equalizing processing device for optical signal according to an embodiment;

FIG. 8 is a schematic diagram of an electrical equalizing processing device for optical signal according to an embodiment;

FIG. 9 is a schematic diagram of an electrical equalizing processing device for optical signal according to an embodiment;

FIG. 10 is a schematic diagram of an optical fiber communication system according to an embodiment; and

FIG. 11 is a schematic diagram of an optical fiber communication system according to another embodiment.

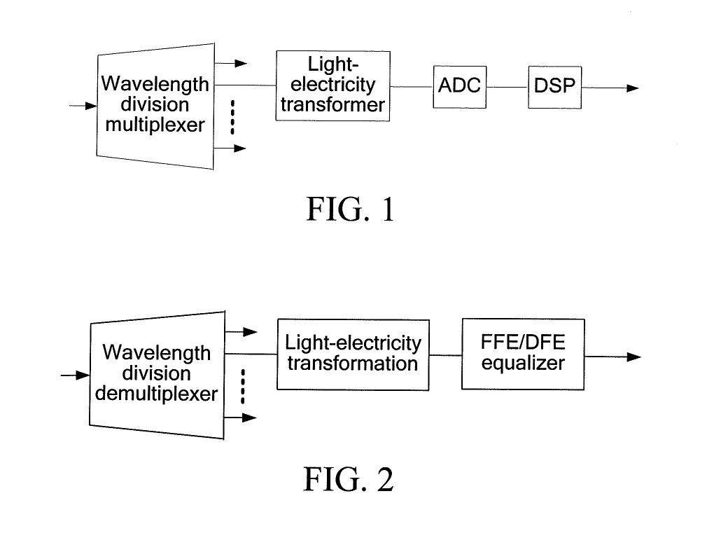

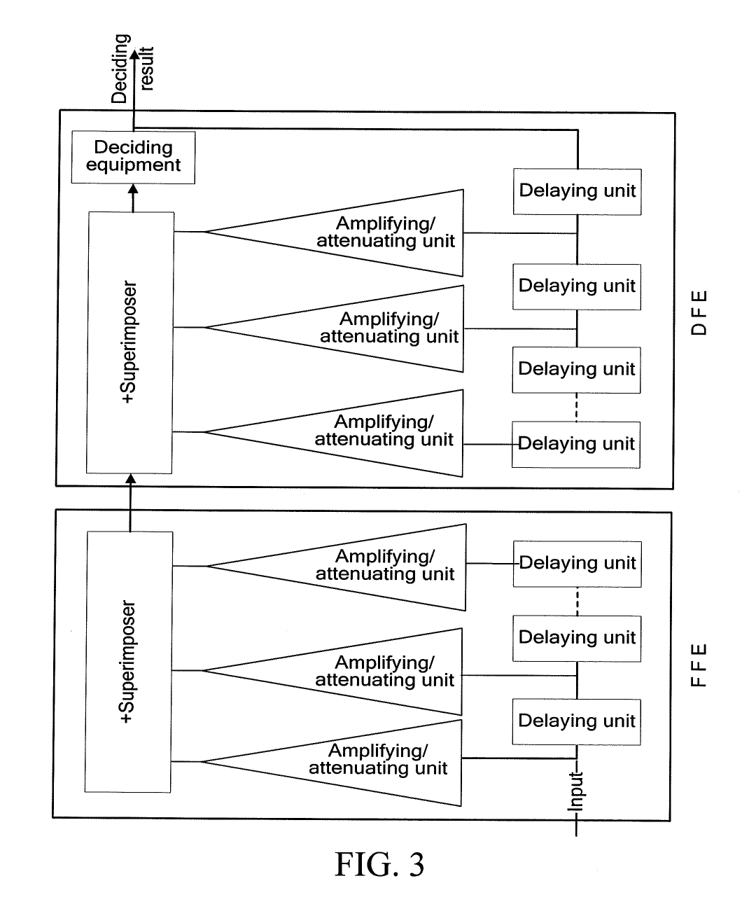

### DETAILED DESCRIPTION OF THE EMBODIMENTS

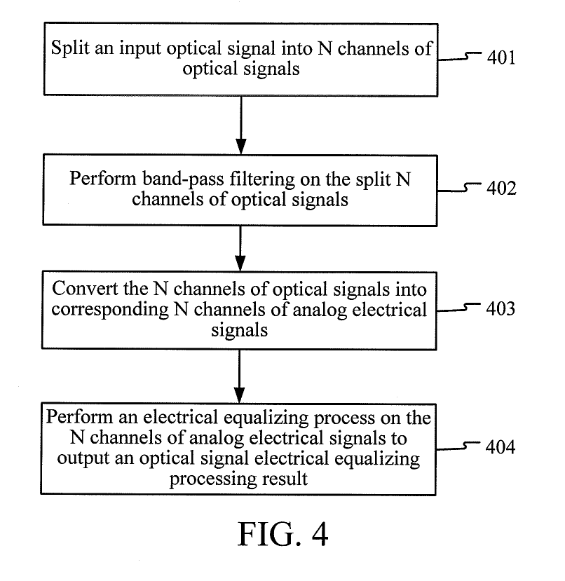

FIG. 4 is a flow chart of an electrical equalizing processing method for optical signal according to an embodiment. The method includes the following steps:

Step S401: Split an input optical signal into N channels of optical signals, in which N is an integer greater than or equal to 2.

A frequency and a baud rate of the split optical signal are the same as that of the input optical signal before splitting.

Step S402: Perform band-pass filtering on the N channels of optical signals, in which central frequencies of a frequency band used in the performing of band-pass filtering on the N channels of optical signals are not exactly the same, and a passband of the frequency band and a frequency spectrum range of the N channels of optical signals overlap.

For example, if N is equal to 2, the central frequencies for performing band-pass filtering on the split two channels of optical signals can be set to respectively deviate from the baud rate of the two channels of optical signals by a factor of ±0.2 compared with the central frequencies of the two channels of optical signals, and the bandwidth is 0.6 times of the baud rate of the two channels of optical signals.

Step S403: Convert the N channels of optical signals on which band-pass filtering is performed into corresponding N channels of analog electrical signals.

Step S404: Perform a joint electrical equalizing process on the N channels of analog electrical signals to output an optical signal electrical equalizing processing result.

In the embodiment, band-pass filtering is performed on the split multiple channels of optical signals, central frequencies of a frequency band used in the performing of band-pass filtering on the optical signal are not exactly the same, and the amplitude of an optical signal on which band-pass filtering is performed is related to both the amplitude and the phase of the input optical signal. After the optical signal is converted to an electrical signal, the optical equalizing processing device can obtain more information about the optical signal, which can reduce the requirement for optical signal to noise ratio under a certain residual dispersion value and the same error rate standards, thereby improving a dispersion margin of the electrical equalizing processing device for optical signal. In addition, as a simulation result shows, the electrical equalizing processing method for optical signal according to the embodiment can compensate the damage caused by non-linearity of the optical fibers in a transmission link to a certain extent.

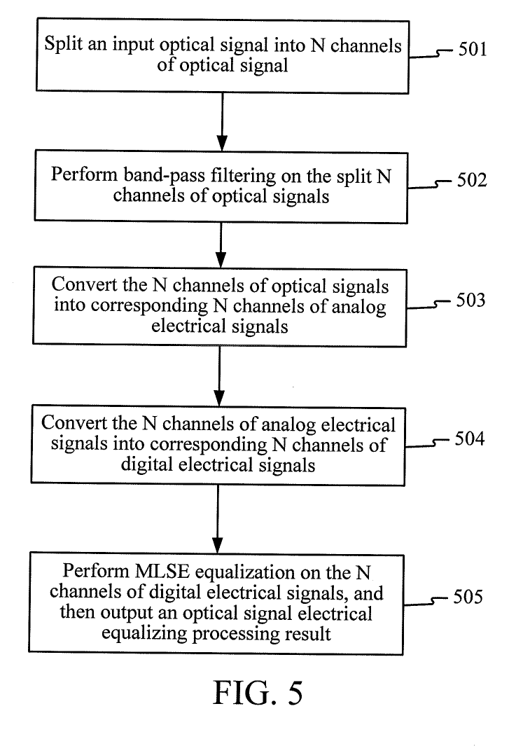

FIG. 5 is a flow chart of an electrical equalizing processing method for optical signal according to another embodiment. The method includes the following steps.

Step S501: Split an input optical signal into N channels of optical signals, in which N is an integer greater than or equal to 2.

Step S502: Perform band-pass filtering on the N channels of optical signals, in which central frequencies of a frequency band used in the performing of band-pass filtering on the N channels of optical signals are not exactly the same, and a passband of the frequency band and a frequency spectrum range of the N channels of optical signals overlap.

Step S503: Convert the N channels of optical signals on which band-pass filtering is performed into corresponding N channels of analog electrical signals.

Step S504: Convert the N channels of analog electrical signals into corresponding N channels of digital electrical signals.

The N channels of analog electrical signals may be converted to corresponding N channels of digital electrical signals in the following manner. The N channels of analog electrical signals are sampled once per bit to obtain corresponding N channels of sampled signals, and the N channels of sampled signals are quantified and then converted to the corresponding N channels of digital electrical signals. Alternatively, the N channels of analog electrical signals are sampled twice or more per bit to obtain corresponding N channels of sampled signals, and the N channels of sampled signals are quantified and then converted to the corresponding N channels of digital electrical signals.

Step S505: Perform an MLSE equalization on the N channels of digital electrical signals, and then output an optical signal electrical equalizing processing result.

The criterion for the MLSE equalizing is formulated as follows:

$$d = arg {max}_{s ∈ S} \sum log ( p ( {y}_{n}^{( 1 )} , {y}_{n}^{( 2 )} , … , {y}_{n}^{( N )} ) \vert s ) )$$

The following approximation can be made to simplify the computations:

$$log ( p ( {y}_{n}^{( 1 )} , {y}_{n}^{( 2 )} , … , {y}_{n}^{( N )} ) \vert s ) ) \approx {\sum }_{k} log ( p ( {y}_{n}^{( k )} \vert s ) )$$

in which yₙ^{(k)}=(yₙ₁^{(k)}, yₙ₂^{(k)}, . . . , y_{nL}^{(k)}) is a vector constituted by samples within the n-th bit period of the k-th channel of the digital signal, with a number of sampling times per period being L.

S is a set of all possible states, p(yₙ^{(k)}|s) is a combined probability density function of receiving sampled electrical signals with a sending state of S, and d is a decided state. The MLSE equalizing can be implemented through Viterbi algorithm.

Because the existing algorithm is not a focus of the embodiment, the Viterbi algorithm is not described in detail.

In the embodiment as shown in FIG. 5, the central frequency of the input optical signal is f0. Firstly, the input optical signal is split into two identical channels of optical signals; secondly, band-pass filtering is performed on the two channels of optical signals, with the central frequencies of a frequency band used in the performing of band-pass filtering on the two channels of optical signals being respectively f1 and 12, in which f1<f0<f2, and f1 and f2 are symmetrical about f0. Without losing generality, it is also possible to set f2<f0<f1, in which f1 and f2 are symmetrical about f0. The two channels of optical signals obtained by performing band-pass filtering are converted to corresponding two channels of analog electrical signals, and the two channels of analog electrical signals are respectively sampled once per bit and quantified, and then converted to corresponding two channels of digital electrical signals. Finally, an MLSE equalization is performed on the two channels of digital electrical signals, and then an optical signal electrical equalizing processing result is output.

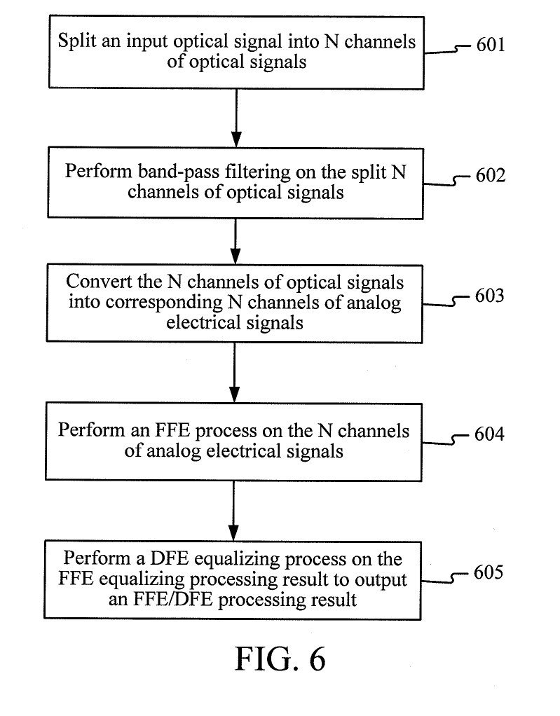

FIG. 6 is a flow chart of an electrical equalizing processing method for optical signal according to another embodiment. The method includes the following steps.

Step S601: Split an input optical signal into N channels of optical signals, in which N is an integer greater or equal to 2.

Step S602: Perform band-pass filtering on the N channels of optical signals, in which central frequencies of a frequency band used in the band-pass filtering for the N channels of optical signals are not exactly the same, and a passband of the frequency band and a frequency spectrum range of the N channels of optical signals overlap.

Step S603: Convert the N channels of optical signals on which band-pass filtering is performed into corresponding N channels of analog electrical signals.

Step S604: Perform an FFE process on the N channels of analog electrical signals to output an FFE processing result.

In the following, an example is taken to illustrate the specific procedure of the FFE process. The N channels of analog signals are respectively delayed for m times to produce corresponding Nm (N times m) channels of signals, with a delaying time used in the m delaying processes of the respective N channels of analog signals being an integer fraction of a signal period. The non-delayed N channels of analog signals and the delayed Nm channels of signals are respectively amplified or attenuated, and the amplified or attenuated N(m+1) channels of signals are linearly superimposed into a one-channel signal for being output.

The coefficient for the amplification or attenuation is determined by a minimum mean square error algorithm. The coefficient can be a positive, zero, or a negative, and the m is an integer equal to or greater than 1. During FFE processing, the minimum mean square error algorithm is one of relatively commonly used methods for determining the coefficient for amplifying or attenuating the non-delayed N channels of analog signals and the delayed Nm channels of signals, such algorithms as constant modulus algorithm can also be used for determining the coefficient in the prior art. Delaying processing time for the respective N channels of analog signals in FFE processing may not be the same. For convenience, only a case in which all the N channels of analog signals are delayed for m times is given here.

Step S605: Perform a DFE process on the FFE processing result to output an FFE/DFE processing result.

The FFE processing result is received, and at the same time, the processing results output and returned after DFE processing are delayed for n times whose delaying time is the signal period, so as to produce corresponding n channels of signals. The delayed n channels of signals are respectively amplified or attenuated, and then linearly superimposed with the FFE processing result into a one-channel signal, and the linearly superimposed one-channel signal is decided to output a DFE processing result. The coefficient for the amplification or attenuation of the delayed n channels of signals respectively can be determined by the minimum mean square error algorithm. The coefficient can be a positive, zero, or a negative, and the n can be an integer equal to or greater than 1. During DFE processing, the minimum mean square error algorithm is one of relatively commonly used methods for determining the coefficient used for amplifying or attenuating the delayed signal, such algorithms as constant modulus algorithm can also be used for determining the coefficient in the prior art.

Both FFE process and DFE process are commonly used equalizing processing methods, and are not repeated in detail herein.

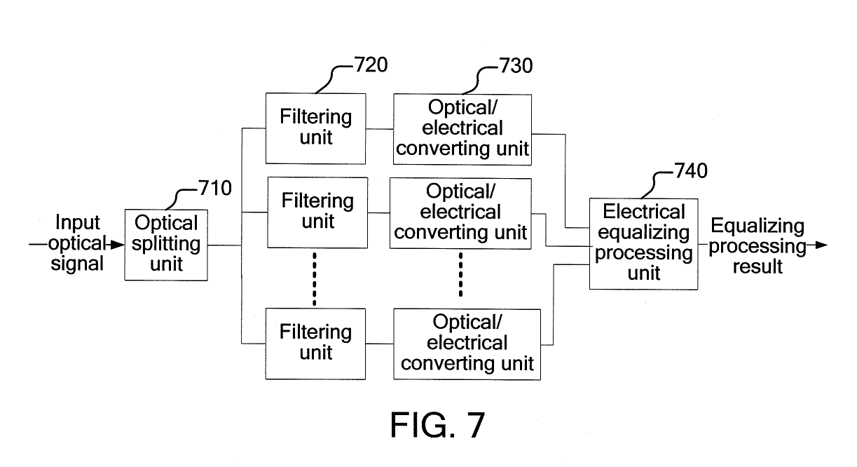

FIG. 7 is a schematic diagram of an electrical equalizing processing device for optical signal according to an embodiment. The electrical equalizing processing device for optical signal includes an optical splitting unit 710, filtering units 720, optical/electrical converting units 730, and an electrical equalizing processing unit 740.

The optical splitting unit 710 is configured to split an input optical signal into N channels of optical signals, in which N is an integer greater than or equal to 2.

The N filtering units 720 corresponding to the N channels of optical signals are configured to perform band-pass filtering on the optical signals corresponding to the N channels of optical signals, in which central frequencies of a frequency band used in the performing of band-pass filtering on the N channels of optical signals are not exactly the same, and a passband of the frequency band and a frequency spectrum range of the N channels of optical signals overlap.

The N optical/electrical converting units 730 corresponding to the N channels of optical signals on which band-pass filtering is performed are configured to convert such optical signals into corresponding N channels of analog electrical signals.

The electrical equalizing processing unit 740 is configured to perform an electrical equalizing process on the N channels of analog electrical signals to output an optical signal electrical equalizing processing result.

In the embodiment, band-pass filtering is performed on the split multiple channels of optical signals, central frequencies of a frequency band used in the performing of band-pass filtering on the optical signal are not exactly the same, and the amplitude of an optical signal on which band-pass filtering is performed is related to both the amplitude and the phase of the input optical signal. After the optical signal is converted to an electrical signal, the optical equalizing processing device can obtain more information about the optical signal, which can reduce the requirement for optical signal to noise ratio under a certain residual dispersion value and the same error rate standards, thereby improving a dispersion margin of the electrical equalizing processing device. In addition, as a simulation result shows, the electrical equalizing processing device according to the embodiment can compensate the damage caused by non-linearity of the optical fibers in a transmission link to a certain extent.

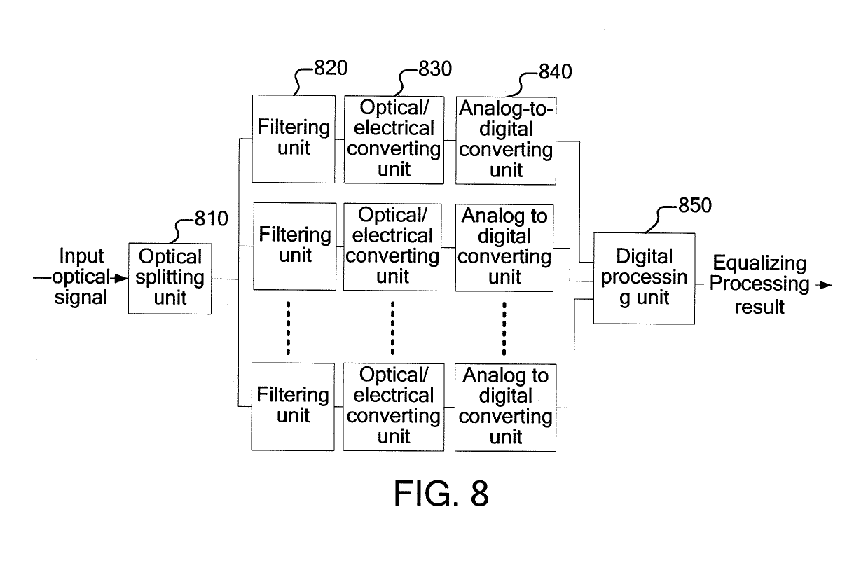

FIG. 8 is a schematic diagram of an electrical equalizing processing device for optical signal according to an embodiment. The electrical equalizing processing device for optical signal includes an optical splitting unit 810, filtering units 820, optical/electrical converting units 830, analog-to-digital converting units 840, and a digital processing unit 850.

The optical splitting unit 810 is configured to split an input optical signal into N channels of optical signals, in which N is an integer greater than or equal to 2.

The N filtering units 820 corresponding to the N channels of optical signals are configured to perform band-pass filtering on the optical signals corresponding to the N channels of optical signals, in which central frequencies of a frequency band used in the performing of band-pass filtering on the N channels of optical signals are not exactly the same, and a passband of the frequency band and a frequency spectrum range of the N channels of optical signals overlap.

The N optical/electrical converting units 830 corresponding to the N channels of optical signals on which band-pass filtering is performed are configured to convert such optical signals into corresponding N channels of analog electrical signals.

The N analog-to-digital converting units 840 corresponding to the N channels of analog electrical signals are configured to convert the N channels of analog electrical signals to corresponding N channels of digital electrical signals.

The digital processing unit 850 is configured to perform an MLSE equalization on the N channels of digital electrical signals to output a best optical signal electrical equalizing processing result.

The analog-to-digital converting units 840 may include a sampling subunit and a quantifying subunit.

The sampling subunit is configured to sample the analog electrical signals to obtain corresponding sampled signals.

The quantifying subunit is configured to quantify the sampled signals and convert the quantified sampled signals to corresponding digital electrical signals.

The sampling subunit performs sampling on the analog electrical signals once per bit to obtain the corresponding sampled signals, and the quantifying subunit quantifies the sampled signals and converts them to the corresponding digital electrical signals.

The sampling subunit provided in the embodiment can obtain corresponding N channels of sampled signals through sampling the N channels of analog electrical signals once per bit. For a special case in which N=2, the embodiment can obtain two channels of optical signals of an upper vestigial sideband and a lower vestigial sideband. Compared with sampling twice per bit by the analog-to-digital converting unit in the prior art and with a premise that the central frequency and bandwidth of the filter are suitable, the analog-to-digital converting unit of the equalizing processing device according to the embodiment performs sampling on the analog electrical signals once per bit, and combines the two channels of sampling to obtain information in an amount that is no less than that obtained by sampling twice per bit in the prior art. Therefore, the analog-to-digital converting unit is easily implemented if the baud rate of the signal is very high. Meanwhile, with a premise that the same dispersion margin is achieved, the number of states of electrical equalization can be reduced, thereby reducing the storage capacity and computing load of the digital signal processing unit.

The central frequency used by each filtering unit in performing of band-pass filtering on one corresponding channel of the optical signal in the N channels of optical signals is the central frequency of the filtering unit. The central frequency of the filtering unit can be greater than the central frequency of the corresponding channel of the optical signal, and can also be less than or equal to the central frequency of the corresponding channel of the optical signal. For example, it can be set that the central frequencies of a portion of the filtering units in the N filtering units are greater than the central frequency of the optical signal corresponding to the filtering units, the central frequencies of a portion of the filtering units are less than the central frequency of the optical signal corresponding to the filtering units, and the central frequencies of a portion of the filtering units are equal to the central frequency of the optical signal corresponding to the filtering units.

For example, if N is equal to 2, the frequency and the signal baud rate of the two channels of optical signals split by the optical splitting unit are the same as those of the optical signal input into the optical splitting unit, the central frequencies for filtering the split two channels of optical signals can be set to respectively deviate from the baud rate of the signal by a factor of ±0.2 compared with the central frequencies of the optical signal, and the bandwidth can be set to be 0.6 times of the baud rate of the signal.

In the embodiment as shown in FIG. 8, the central frequency of the input optical signal is f0. Firstly, the input optical signal is split by the optical splitting unit 810 into two identical channels of optical signals; secondly, each channel of the optical signal is filtered by the filtering unit 820 with the central frequencies being f1 and f2, in which f1<f0<f2, and f1 and 12 are symmetrical about f0. Without losing generality, it is also possible to set f2<f0<f1, in which f1 and f2 are symmetrical about f0. The two channels of optical signals obtained by filtering respectively pass through the optical/electrical converting unit 830, and then pass through the analog-to-digital converting unit 840 for being converted to two channels of digital electrical signals after being sampled and quantified once per bit. Finally, the digital electrical signals are sent to the digital processing module 850 for being MLSE decided, so as to output an optical signal electrical equalizing processing result.

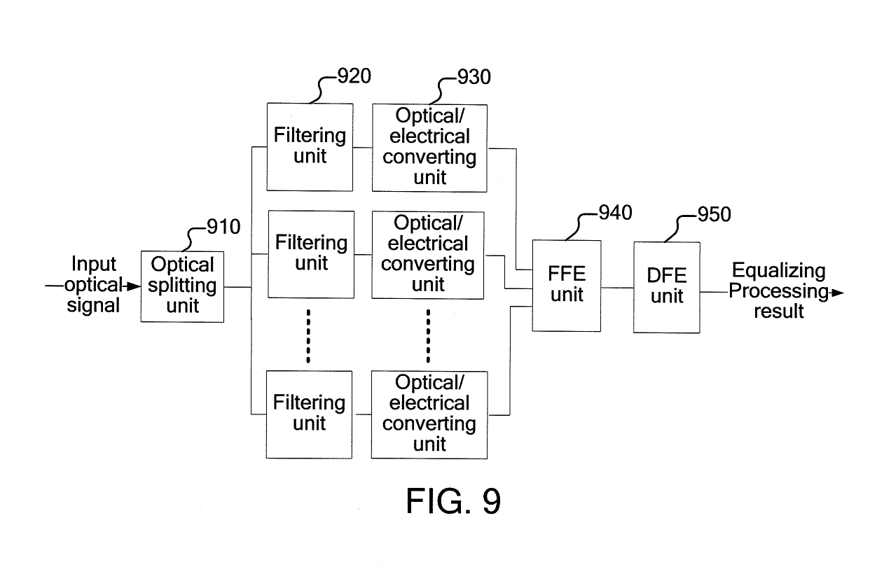

FIG. 9 is a schematic diagram of an electrical equalizing processing device for optical signal according to an embodiment. The electrical equalizing processing device for optical signal includes an optical splitting unit 910, filtering units 920, optical/electrical converting units 930, an FFE unit 940, and a DFE unit 950.

The optical splitting unit 910 is configured to split an input optical signal into N channels of optical signals, in which N is an integer greater than or equal to 2.

The N filtering units 920 corresponding to the N channels of optical signals are configured to perform band-pass filtering on the optical signals corresponding to the N channels of optical signals, in which central frequencies of a frequency band used in the performing of band-pass filtering on the N channels of optical signals are not exactly the same, and a passband of the frequency band and a frequency spectrum range of the N channels of optical signals overlap.

The N optical/electrical converting units 930 corresponding to the N channels of optical signals on which band-pass filtering is performed are configured to convert such optical signals into corresponding N channels of analog electrical signals.

The FFE processing unit 940 is configured to perform an FFE process on the N channels of analog electrical signals and output an FFE processing result.

The FFE processing unit 940 respectively delays the N channels of analog signals for m times to produce corresponding Nm (N times m) channels of signals with a delaying time used in the m delaying processes of the respective N channels of analog signals being an integer fraction of a signal period, and respectively amplifies or attenuates the non-delayed N channels of analog signals and the delayed Nm channels of signals, and linearly superimposes the amplified or attenuated N(m+1) channels of signals into a one-channel signal to output the FFE processing result.

The coefficient for the amplification or attenuation is determined by a minimum mean square error algorithm. The coefficient can be a positive, zero, or a negative, and the m is an integer equal to or greater than 1. During FFE processing, the minimum mean square error algorithm is one of relatively commonly used methods for determining the coefficient for amplifying or attenuating the non-delayed N channels of analog signals and the delayed Nm channels of signals, such algorithms as constant modulus algorithm can also be used for determining the coefficient in the prior art. Delaying processing time for the respective N channels of analog signals in FFE processing may not be the same. For convenience, only a case in which all the N channels of analog signals are delayed for m times is given here.

The DFE processing unit 950 is configured to receive the FFE processing result output by the FFE processing unit 940 and perform a DFE process on the FFE processing result to output an FFE/DFE processing result.

A DFE equalizer receives the FFE processing result, and at the same time, delays the processing results output and returned by the DFE equalizer itself for n times whose delaying time is the signal period, so as to produce corresponding n channels of signals, and respectively amplifies or attenuates the delayed n channels of signals and then linearly superimposes them with the FFE processing result into a one-channel signal, and the linearly superimposed one-channel signal is decided to output the DFE processing result. The coefficient for the amplification or attenuation of the delayed n channels of signals respectively can be determined by the minimum mean square error algorithm, the n can be an integer equal to or greater than 1. During DFE processing, the minimum mean square error algorithm is one of relatively commonly used methods for determining the coefficient used for amplifying or attenuating the delayed signal, such algorithms as constant modulus algorithm can also be used for determining the coefficient in the prior art.

Both FFE process and DFE process are commonly used equalizing processing methods, and are not a focus; therefore, they are not repeated in detail herein.

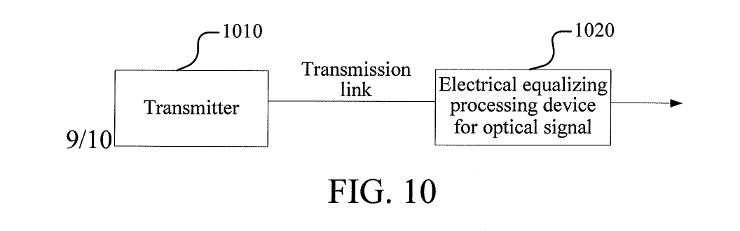

FIG. 10 is a schematic diagram of an optical fiber communication system according to an embodiment. The optical fiber communication system includes an electrical equalizing processing device for optical signal 1020 connected to a transmitter 1010 by using a transmission link. The electrical equalizing processing device for optical signal 1020 is configured to perform the following operations.

An optical signal that is received from the transmitter 1010 is split into N channels of optical signals, in which N is an integer greater than or equal to 2.

Band-pass filtering is performed on the N channels of optical signals, in which central frequencies of a frequency band used in the performing of band-pass filtering on the N channels of optical signals are not exactly the same, and a passband of the frequency band and a frequency spectrum range of the N channels of optical signals overlap.

The N channels of optical signals on which band-pass filtering is performed are converted into corresponding N channels of analog electrical signals.

An electrical equalizing process is performed on the N channels of analog electrical signals to output an optical signal electrical equalizing processing result.

The transmitter 1010 is configured to output the optical signal.

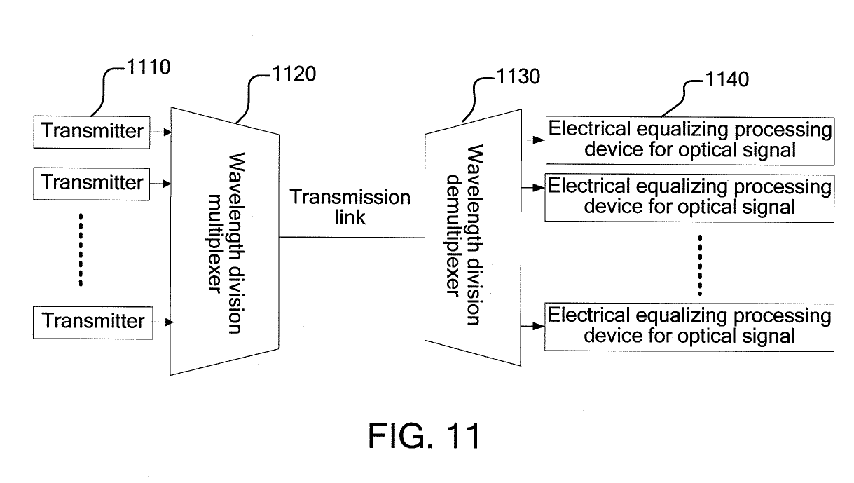

FIG. 11 is a schematic diagram of an optical fiber communication system according to another embodiment. The difference between the optical fiber communication system in this embodiment and the optical fiber communication system shown in FIG. 10 is that the optical fiber communication system includes M transmitters 1110 and M electrical equalizing processing device for optical signals 1140 provided in the embodiments, in which M is an integer equal to or greater than 2, and further includes a wavelength division multiplexer 1120 and a wavelength division demultiplexer 1130.

The transmitter 1110 is configured to output an optical signal.

The wavelength division multiplexer 1120 is configured to multiplex M channels of optical signals output by the M transmitters into a one-channel optical signal and then output.

The wavelength division demultiplexer 1130 is configured to receive the one-channel optical signal input from the wavelength division multiplexer 1120, split the one-channel optical signal into M channels of optical signals and then output to the corresponding M electrical equalizing processing device for optical signals.

The wavelength division multiplexer 1120 and the wavelength division demultiplexer 1130 are connected by using a transmission link.

The electrical equalizing processing devices for optical signal 1140 are configured to receive the optical signal output by the wavelength division demultiplexer 1130 and split the received optical signal into N channels of optical signals, in which N is an integer greater than or equal to 2;

perform band-pass filtering on the N channels of optical signals, in which central frequencies of a frequency band used in the band-pass filtering for the N channels of optical signals are not exactly the same, and a passband of the frequency band and a frequency spectrum range of the N channels of optical signals overlap;

convert the N channels of optical signals on which band-pass filtering is performed into corresponding N channels of analog electrical signals; and

perform an electrical equalizing process on the N channels of analog electrical signals to output an optical signal electrical equalizing processing result.

In the embodiments, band-pass filtering is performed on the split multiple channels of optical signals, central frequencies of a frequency band used in the performing of band-pass filtering on the optical signal are not exactly the same, and the amplitude of an optical signal on which band-pass filtering is performed is related to both the amplitude and the phase of the input optical signal. After the optical signal is converted to an electrical signal, the optical equalizing processing device can obtain more information about the optical signal, which can reduce the requirement for optical signal to noise ratio under a certain residual dispersion value and the same error rate standards, thereby improving a dispersion margin of the electrical equalizing processing device. In addition, as a simulation result shows, the electrical equalizing processing device according to the embodiments can compensate the damage caused by non-linearity of the optical fibers in a transmission link to a certain extent.

What are described in detail above are an electrical equalizing processing method for optical signal, device and an optical fiber communication system provided in the embodiments. It is apparent that person having ordinary skill in the art can make variations and modifications to the present invention in terms of the specific implementations and application scopes according to the ideas. Therefore, the specification shall not be construed as limitations to the claims.

What is claimed is:

1. An electrical equalizing processing method for optical signal, comprising:
splitting an input optical signal into N channels of optical signals, wherein N is an integer greater than or equal to 2;
performing band-pass filtering on the N channels of optical signals, wherein central frequencies of a frequency band used in the performing of band-pass filtering on the N channels of optical signals do not match, and a passband of the frequency band and a frequency spectrum range of the N channels of optical signals overlap;
converting the N channels of optical signals on which band-pass filtering is performed into corresponding N channels of analog electrical signals; and
performing an electrical equalizing process on the N channels of analog electrical signals to output an optical signal electrical equalizing processing result.

2. The method according to claim 1, wherein performing the electrical equalizing process on the N channels of analog electrical signals to output the optical signal electrical equalizing processing result comprises:
converting the N channels of analog electrical signals to corresponding N channels of digital electrical signals; and
performing a maximum likelihood sequence estimation (MLSE) equalization on the N channels of digital electrical signals, and
outputting the optical signal electrical equalizing processing result.

3. The method according to claim 2, wherein converting the N channels of analog electrical signals to the corresponding N channels of digital electrical signals comprises:
sampling the N channels of analog electrical signals to obtain corresponding N channels of sampled signals; and
converting the N channels of sampled signals to the corresponding N channels of digital electrical signals after quantifying the N channels of sampled signals.

4. The method according to claim 1, wherein performing the electrical equalizing process on the N channels of analog electrical signals to output the optical signal electrical equalizing processing result comprises:
performing a feed forward equalization (FFE) process on the N channels of analog electrical signals to output an FFE processing result; and
performing a decision feedback equalization (DFE) process on the FFE processing result to output an FFE/DFE processing result.

5. The method according to claim 1, wherein N is 2, and differences between the central frequencies used in the performing of band-pass filtering on the split two channels of optical signals and a central frequency of the input optical signal match in absolute value, and are symmetrical about the central frequency of the input optical signal.

6. The method according to claim 2, wherein N is 2, and differences between the central frequencies used in the performing of band-pass filtering on the split two channels of optical signals and a central frequency of the input optical signal match in absolute value, and are symmetrical about the central frequency of the input optical signal.

7. The method according to claim 3, wherein N is 2, and differences between the central frequencies used in the performing of band-pass filtering on the split two channels of optical signals and a central frequency of the input optical signal match in absolute value, and are symmetrical about the central frequency of the input optical signal.

8. The method according to claim 4, wherein N is 2, and differences between the central frequencies used in the performing of band-pass filtering on the split two channels of optical signals and a central frequency of the input optical signal match in absolute value, and are symmetrical about the central frequency of the input optical signal.

9. An electrical equalizing processing device for optical signal, comprising:
an optical splitting unit configured to split an input optical signal into N channels of optical signals, wherein N is an integer greater than or equal to 2;
N filtering units corresponding to the N channels of optical signal, configured to perform band-pass filtering on the optical signals corresponding to the N channels of optical signals, wherein central frequencies of a frequency band used in the performing of band-pass filtering on the N channels of optical signals do not match, and a passband of the frequency band and a frequency spectrum range of the N channels of optical signals overlap;
N optical/electrical converting units corresponding to the filtered N channels of optical signal on which band-pass filtering is performed configured to convert the optical signals into corresponding N channels of analog electrical signals; and
an electrical equalizing processing unit, configured to perform an electrical equalizing process on the N channels of analog electrical signals to output an optical signal electrical equalizing processing result.

10. The device according to claim 9, wherein the electrical equalizing processing unit comprises:
N analog-to-digital converting units corresponding to the N channels of the analog electrical signal configured to convert the N channels of analog electrical signals to corresponding N channels of digital electrical signals; and
a digital processing unit configured to perform a maximum likelihood sequence estimation (MLSE) equalization on the N channels of digital electrical signals, and output the optical signal electrical equalizing processing result.

11. The device according to claim 10, wherein the analog-to-digital converting units comprise:
a sampling subunit configured to sample corresponding analog electrical signal to obtain corresponding sampled signals; and
a quantifying subunit configured to quantify the sampled signals and convert the quantified sampled signals to corresponding digital electrical signals.

12. The device according to claim 9, wherein the electrical equalizing processing unit comprises:
a feed forward equalization (FFE) processing unit, configured to perform an FFE process on the N channels of analog electrical signals and output an FFE processing result; and
a decision feedback equalization (DFE) processing unit, configured to perform a DFE process on the FFE processing result and output an FFE/DFE processing result.

13. An optical fiber communication system, comprising an electrical equalizing processing device for optical signal connected to a transmitter by using a transmission link, wherein the electrical equalizing processing device for optical signal is configured to:
receive an optical signal transmitted from the transmitter, and split the received optical signal into N channels of optical signals, wherein N is an integer greater than or equal to 2;
perform band-pass filtering on the N channels of optical signals, wherein a passband of a frequency band used in the performing of band-pass filtering on the N channels of optical signals and a frequency spectrum range of the N channels of optical signals overlap;
convert the channels of optical signals on which band-pass filtering is performed into corresponding N channels of analog electrical signals; and
perform an electrical equalizing process on the N channels of analog electrical signals to output an electrical equalizing processing result of the optical signal.

14. The optical fiber communication system according to claim 13, wherein the optical fiber communication system comprises one electrical equalizing processing device for optical signal, the optical fiber communication system further comprises:
one transmitter, configured to output an optical signal to the electrical equalizing processing device for optical signal.

15. The optical fiber communication system according to claim 13, wherein the optical fiber communication system comprises M electrical equalizing processing devices for optical signal, M is an integer equal to or greater than 2; wherein, the optical fiber communication system further comprises:
M transmitters, configured to output the optical signals;
a wavelength division multiplexer, configured to receive M channels of optical signals output by the M transmitters and multiplex the M channels of optical signals into a one-channel optical signal and then output; and
a wavelength division demultiplexer, configured to receive the one-channel optical signal input from the wavelength division multiplexer, split the one-channel optical signal into M channels of optical signals and then output to corresponding M electrical equalizing processing devices for optical signal.
